(19) United States
(12) Patent Application Publication
(10) Pub. No.: US 2024/0306754 A1
(43) Pub. Date: Sep. 19, 2024

(54) ILLUMINATING HEADWEAR DEVICE AND KIT

(71) Applicant: Ronald H. Walters, Easton, PA (US)

(72) Inventor: Ronald H. Walters, Easton, PA (US)

(21) Appl. No.: 18/121,134

(22) Filed: Mar. 14, 2023

(51) Int. Cl. A42B 3/04; A41B 1/08; A41D 1/04; A41D 13/01; A41D 31/32; A42B 3/32; F21V 21/084; F21V 23/04

(52) U.S. Cl. CPC A42B 3/044; A41B 1/08; A41D 1/04; A41D 13/01; A41D 31/32; A42B 3/324; F21V 21/084; F21V 23/04

(57) ABSTRACT

An illuminating headwear device and kit are shown and described. The illuminating headwear device and kit includes a headwear device. The headwear device is configured to removably secure about the head of an individual. The headwear devices also include a power source. The power source is coupled to at least one light. The at least one light is secured to the headwear device such that the light is pointed in a direction which will, at least partially, illuminate the individual's shoulders, torso, and back when the headwear device is worn. In one instance an on/off switch will allow for the at least one light be turned on and off. The kit further includes an illumination garment. The illumination garment will glow when the beam from the at least one light hits it.

### BACKGROUND OF THE INVENTION

The present invention relates to illumination devices. More particularly, the present invention provides an illuminating device which will better enable the sighting of individuals in dark- or low light environments.

Currently, there are several professions where safety is a major concern for those who have chosen the occupation. One of which is that of the construction worker or contractor. Among other things one of the dangers which is faced comes not from the work or the work place, but from the surroundings and locations where conducting the work is necessary. Roadway construction is extremely hazardous as individuals are performing work around traffic areas. Over the last two decades there have been roughly an average of 123 workers per year who have lost their lives in roadway construction collisions. Further, the number of constructions site accidents sharply increased around 2018 and has stayed steadily high over the past five years.

In some instances, in an effort to reduce such accidents from congested roadways or high trafficked areas, road work is often completed at night. While the data supports that there are less crashes-therefore less injuries and fatalities at night working during the nighttime presents an entirely new challenge. During the day workers are more easily visible. At night however, they can become difficult to spot and often may not be seen until the last few seconds. This is especially true for vehicles traveling at a high rate of speed on road ways with little additional lighting.

In an effort to be seen, workers are required to wear certain safety gear. Primarily hardhats and vests, which are of a neon color and at least partially reflective. These items stand out great when a light is shown on them however, a light is not always there to shine. This is compounded by the limited amount of time for one to see a person once light is shown upon them.

For example, a road sign with 3-inch letters can be seen at around 100 feet by most individuals—while 10 inch road sign letters can be seen at 450 feet. Further, an average passenger vehicle will only throw a beam of light from the headlights is 350 feet. At 35 miles per hour a vehicle is traveling at roughly 50 feet per second. This means that at night a driver only has at most (assuming at least 10 inches of the worker is visible) 7 seconds (only 4.5 seconds at 55 miles per hour) to spot someone and react. When compiled with the other aspects that naturally come with driving—this is not a great amount of time.

If a vehicle was able to spot an individual from further away there would be more reaction time and thus less collisions. Consequently, there is a need for an improvement in the art of visibility enabling safety equipment. The present invention substantially diverges in design elements from the known art while at the same time solves a problem many people face when attempting to be seen while on a construction site. In this regard the present invention substantially fulfills these needs.

### SUMMARY OF THE INVENTION

The present invention provides an illuminating headwear device and kit wherein the same can be utilized for providing convenience for the user when operating on a low light construction site. The illuminating headwear device includes a headwear device which is configured to removably secure about the head of an individual. A power source coupled to the headwear device. At least one light operably coupled to the power source and the headwear device. The light is pointed in a direction which will, at least partially, illuminate the individual's shoulders, torso, and back when the headwear device is worn.

Another object of the illuminating headwear is to have the diameter of the headwear device is adjustable in size to better fit the individual.

Another object of the illuminating headwear is to have an on/off switch operably coupled between the power source and the at least one light.

Another object of the illuminating headwear is to have the at least one second light operably coupled to the power source and the headwear device.

Another object of the illuminating headwear is to have an on/off switch operably coupled between the power source and the at least one second light.

Another object of the illuminating headwear is to have at least one second light is configured to point in a direction in front of an away from the individuals face.

Another object of the illuminating headwear is to have the headwear device be a hardhat.

Another object of the illuminating headwear is to have the at least one light be a black light.

Another object of the illuminating headwear is to include an illumination garment as part of a kit. The illumination garment will react with the light to add a glow to the individual.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an individual wearing an embodiment of a kit including the illuminating headwear device.

FIG. 1B shows a perspective view of an individual wearing an embodiment of the kit including the illuminating headwear device.

FIG. 2A shows a perspective bottom-up view of an embodiment of the illuminating headwear device.

FIG. 2B shows a perspective bottom-up view of an embodiment of the illuminating headwear device.

FIG. 3 shows an exploded view of an embodiment of the illuminating headwear device and the other parts of the kit.

FIG. 4 shows a wiring diagram on an embodiment of the illuminating headwear device.

### LIST OF REFERENCE NUMERALS

With regard to the reference numerals used, the following numbering is used throughout the drawings.

| | |
|---|---|
| 101 | Headwear Device |
| 102 | First Light |
| 102A | Plurality of Lights |
| 103 | Individual User |
| 103A | User's Shoulders |
| 103B | User's Torso |
| 103C | User's Back |
| 103D | User's Face |
| 104 | Illumination Garment |
| 104A | Secondary Beam |
| 104B | T-Shirt |
| 104C | Vest |
| 104D | Reflective Strips |
| 105 | Second Light |
| 105A | Plurality of Lights |
| 105B | Housing |
| 201 | Power Source |
| 201A | Strap |
| 301 | Hard Hat |
| 301A | Inner Straps |
| 301B | Brim |
| 301C | Enclosure |
| 302 | First Switch |
| 303 | Second Switch |

### DETAILED DESCRIPTION OF THE INVENTION

Reference is made herein to the attached drawings. Like reference numerals are used throughout the drawings to depict like or similar elements of the illuminating headwear device and kit. For the purposes of presenting a brief and clear description of the present invention, a preferred embodiment will be discussed as used for the illuminating headwear device and kit. The figures are intended for representative purposes only and should not be considered to be limiting in any respect.

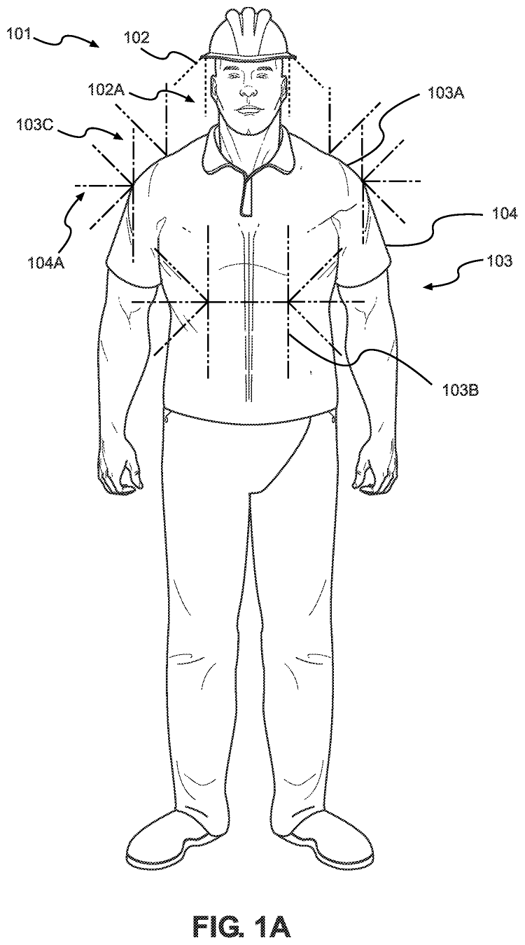

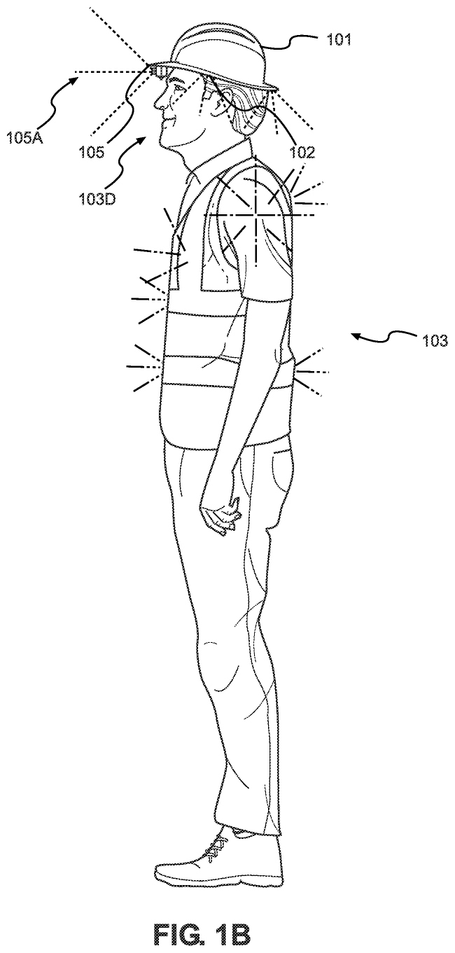

Referring now to FIG. 1A and FIG. 1B, there is shown perspective views of an individual wearing an embodiment of a kit including the illuminating headwear device. In each of these embodiments the illuminating headwear device 101 and the rest of the illumination kit are comprised of substantially the same items with only a few alterations or optional features added. Further, the description provided herein uses a hard hat as an example of a headwear device. However, one of ordinary skill in the art will understand that many different headwear devices may be used which are still capable of attaching at least one first light thereto. This will enable different headwear devices to provide the same safety effect as a hardhat. In different embodiments the at least one first light may be placed at different distances from an individual's head. There is no preferred distance so long as at least part of the light from the at least one first light shines onto the individual.

In FIG. 1A the illuminating headwear device 101 includes at least one first light 102 attached thereto. In one embodiment the at least one first light 102 is a black light. In another embodiment the at least one first light 102 is an ultra-violet light. In yet another embodiment the at least one first light 102 is an LED light, such as a purple LED light.

This least one first light 102, when activated shines down onto an individual user 103 such that the shoulders 103A, torso 103B, and back 103C will illuminate. As part of the kit the individual user 103 wears a specially selected illumination garment 104. When the illumination garment 104 is struck by the light beams 102A coming from the least one first lights the beams 102A will reflect and create a secondary beam 104A which will illuminate the illumination garment 104.

In FIG. 1B. the kit and the operation is substantially the same. However, the illumination headwear device 102 has several alterations made thereto. Here the at least one first light 102 does not travel the full circumference of the illumination headwear device 101. Instead, it there is an opening left about the individual user's face 103D. In one embodiment the at least one first light 102 stops at about the temple area of the individual user 103.

In one embodiment there is a gap created by the stoppage of the at least one first light 102. In another embodiment at least one second light 105 may be put in place. In one embodiment the at least one second light 105 will function as a head lamp. This embodiment will allow for the individual user 103 to be able to better see in front of them without the need for additional equipment. In this embodiment the beam 105A from the at least one second light 105 is shown pointed out and away from the individual user 103. In another embodiment the at least one second light 105 may be a flashing light to better attract attention to the individual user 103.

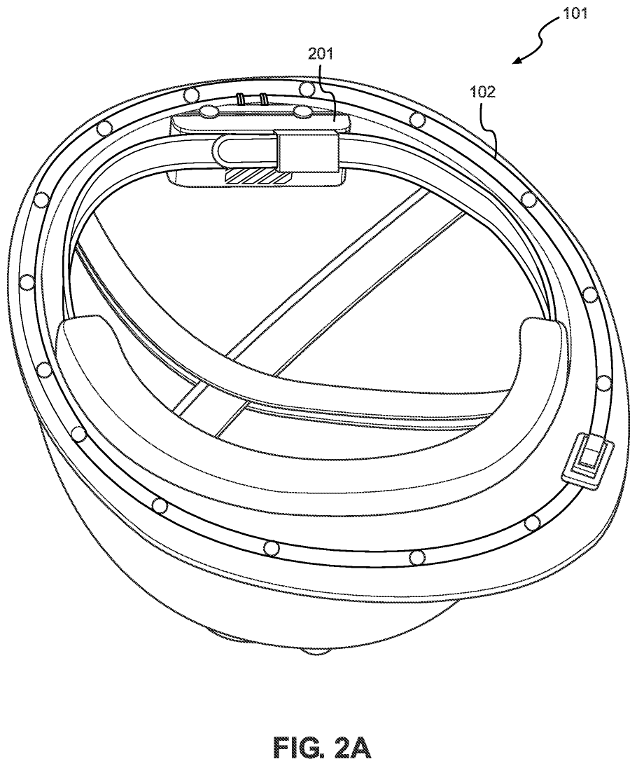

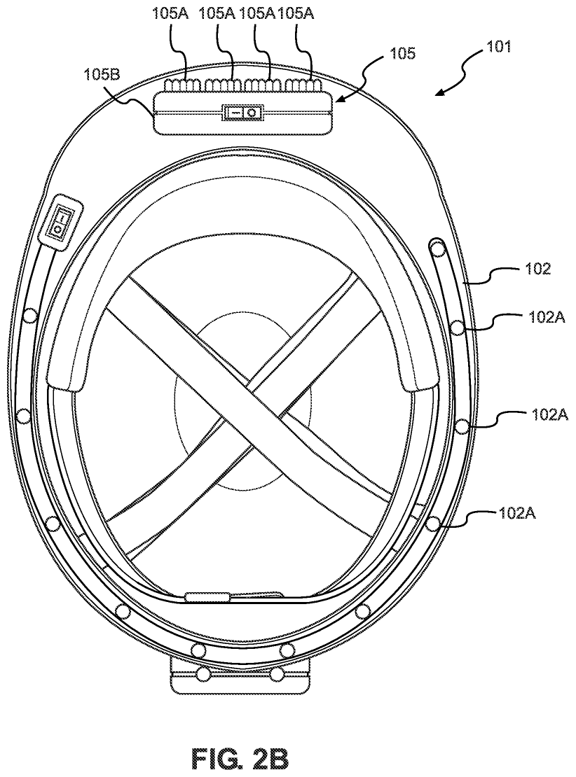

Referring now to FIG. 2A, there is shown a perspective bottom-up view of an embodiment of the illuminating headwear device 101. The illuminating headwear device 101 is shown incorporating a power source 201. In one embodiment the power source 201 is located on a back side of the illumination headwear device 101. From this angle a better view is given of the at least one first light 102. In the shown embodiment the at least one first light 102 does not fully encircle the circumference of the illuminating headwear device 101. Instead, the at least one first light 102 stops and leaves a gap similar to the embodiment of FIG. 1B. Here however, there are no additional lights.

Referring now to FIG. 2B, there is shown a perspective bottom-up view of an embodiment of the illuminating headwear device 101. In this embodiment the at least one first light 102 is part of a plurality of lights 102A. In one embodiment the plurality of lights 102A is a string of lights. In one embodiment the plurality if lights 102A are connected to a light strip. In another embodiment the plurality of lights 102A are house in a tube light. Embodiments with a plurality of lights 102A, while not necessary, could provide some advantages. First, there are redundancies in case of a burnout. Second, using a plurality of light 102As will allow for the lights to more easily be worked around the illuminating headwear device 101.

In the shown embodiment the at least one second light 105 is part of a second plurality of lights 105A. In one embodiment the second plurality of lights 105A are all located within a single housing 105B. This will allow for the lights to be easily protected and mounted to the illuminating headwear device 101. Further using a plurality of lights will provide for the same benefits and listed above.

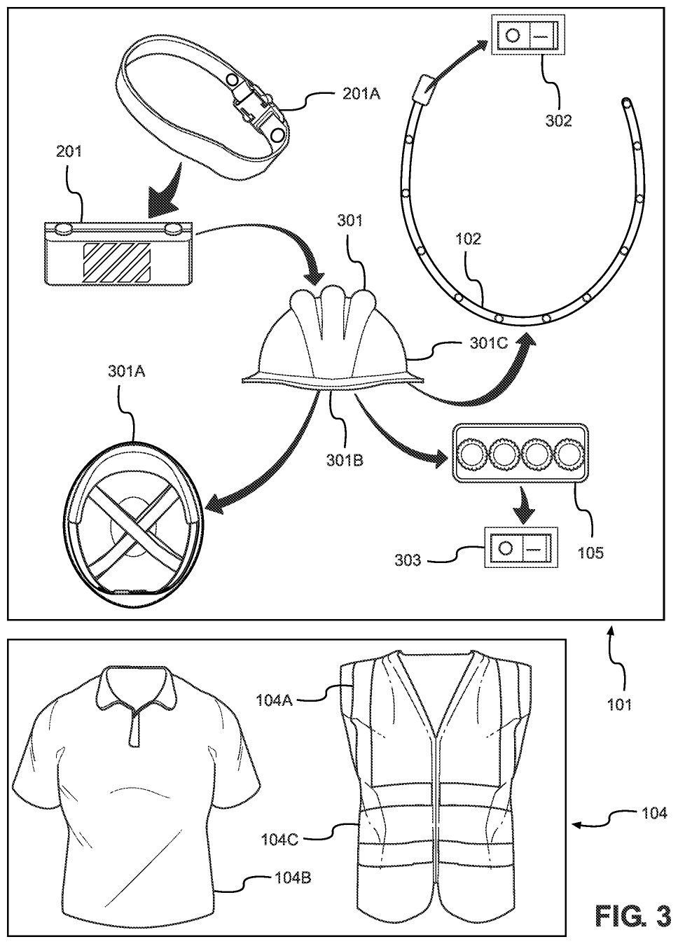

Referring now to FIG. 3, there is shown an exploded view of an embodiment of the illuminating headwear device 101 and the other parts of the kit. There are two main items for the kit, the first is the illuminating headwear device 101, and the second is the illuminating garment 104.

In one embodiment the illuminating garment 104 is a T-shirt 104B. In another embodiment the illuminating garment 104 is a vest 104C. In other embodiments other forms of clothing may be used as the illuminating garment 104. In each embodiment the illuminating garment 104 is of a color or material that when paired with the correct at least one first light 102 will cause the illuminating garment 104 to light up. In one some embodiments that means the illuminating garment 104 will be neon colored. In other embodiments a white color will be used. In yet other embodiments additional reflective strips 104D are added to the illuminating garment 104. These strips will add additional reflection.

The illuminating headwear device 101 may be constructed using any number of base headwear. Primarily in the shown and described embodiments a hard hat 301 is used. However, other headwear such as baseball caps, cowboy hats, bucket hats, or even a knitted hat could potentially be used. In the embodiment of the hard hat 301 the illuminating headwear device 101 is comprising of a hard hat 301 and the associated components. These components include a plurality of inner straps 301A, a brim 301B and the part of the hat which encloses an individual user's head 301C. Having the plurality of inner straps 301A allows for the hard hat 301 to be adjustable and to fit a wide range of individual users 103.

Attached to the illuminating headwear device 101 is a power source 201. In one embodiment the power source 201 is secured to the illuminating headwear device 101 via a strap 201A. The strap 201A will allow for the power source 201 to be removed. Further, as described above, the illuminating headwear device 101 includes at least one first light 102. In some embodiments there is a first on/off switch 302 which allows for the at least one first light 102 to be activated or deactivated.

In some embodiments, as described above, the illuminating headwear device 101 includes at least one second light 105. In some embodiments there is a second on/off switch 303 which allows for the at least one second light 105 to be activated or deactivated.

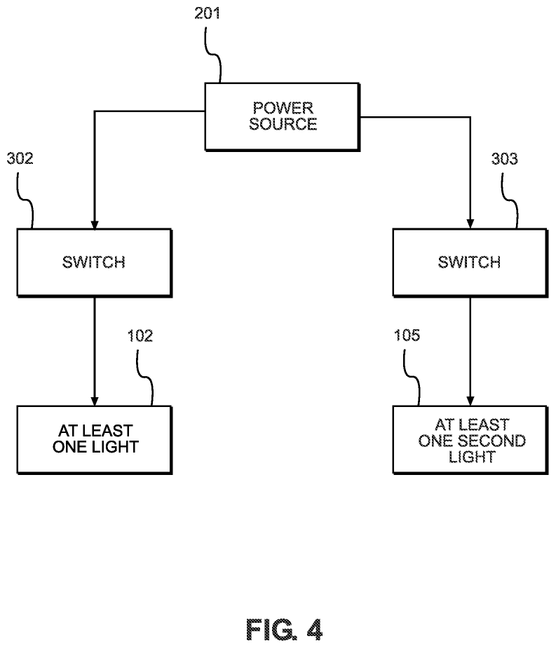

Referring now to FIG. 4, there is shown a wiring diagram on an embodiment of the illuminating headwear device 101. In one embodiment the power source 201 is coupled to a first on/off switch 302. In one embodiment t the power source 201 is a battery pack. In another embodiment the battery pack is rechargeable. The first on/off switch 302 is coupled to the at least one first light 102. This connection will allow the individual user 103 to activate or disactivate the at least one first light 102.

The power source 201 is also coupled to a second on/off switch 303. The second on/off switch 303 is coupled to the at least one second light 105. This connection will allow the individual user 103 to activate or disactivate the at least one second light 105.

In various embodiments the first on/off switch 302 and the second on/off switch 303 may be number of applicable switches. In one embodiment the first on/off switch 302 and the second on/off switch 303 are toggle switches. In another embodiment the first on/off switch 302 and the second on/off switch 303 is a flip switch. In yet another embodiment the first on/off switch 302 and the second on/off switch 303 are buttons that will allow for activation and deactivation of the lights.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) (canceled)

2) (canceled)

3) (canceled)

4) (canceled)

5) (canceled)

6) (canceled)

7) (canceled)

8) (canceled)

9) (canceled)

10) An illuminating headwear device and kit, the kit comprising:
a headwear device, wherein the headwear device is configured to removably secure about the head of an individual;
a power source coupled to the headwear device;
at least one light operably coupled to the power source and the headwear device, wherein the light is pointed in a direction which will, at least partially, illuminate the individual's shoulders, torso, and back when the headwear device is worn;
the kit is further comprised of an illumination garment, wherein the illumination garment reflects the light based solely on the illumination garments color properties.

11) The illuminating headwear device and kit of claim 10, wherein a diameter of the headwear device is adjustable in size to better fit the individual.

12) The illuminating headwear device and kit of claim 10, further comprising an on/off switch operably coupled between the power source and the at least one light.

13) The illuminating headwear device and kit of claim 10, further comprising at least one second light operably coupled to the power source and the headwear device.

14) The illuminating headwear device and kit of claim 13, further comprising an on/off switch operably coupled between the power source and the at least one second light.

15) The illuminating headwear device and kit of claim 13, wherein the at least one second light is configured to point in a direction in front of an away from the individuals face.

16) The illuminating headwear device and kit of claim 10, wherein the headwear device is a hardhat.

17) The illuminating headwear device and kit of claim 10, wherein the at least one light is a black light.

18) The illuminating headwear device and kit of claim 10, wherein the illumination garment is a vest.

19) The illuminating headwear device and kit of claim 10, wherein the illumination garment is a shirt.

20) The illuminating headwear device and kit of claim 10, wherein the illumination garment is a reflective neon color which under certain lights will glow.
